(19) United States
(12) Patent Application Publication
(10) Pub. No.: US 2011/0113232 A1
(43) Pub. Date: May 12, 2011

(54) METHODS, APPARATUSES, AND COMPUTER PROGRAM PRODUCTS FOR MEMORY MANAGEMENT IN DEVICES USING SOFTWARE DEFINED RADIOS

(75) Inventor: Johannes Westmeijer, Dorsten (DE)

(73) Assignee: NOKIA CORPORATION, Espoo (FI)

(21) Appl. No.: 13/001,582

(22) PCT Filed: Jun. 27, 2008
(86) PCT No.: PCT/IB2008/052608

§ 371 Date: Dec. 27, 2010

(51) Int. Cl. G06F 9/445

(52) U.S. Cl. 713/2

(57) ABSTRACT

An apparatus may include a processor configured to maintain a profile comprising data about software defined radio usage. The processor may be further configured to determine a subset of the plurality of software defined radios. The processor may be additionally configured to determine computing resources required for loading an available software defined radio that is not currently loaded into the memory based at least in part upon the maintained profile and the determined subset. The processor may also be configured to determine based at least in part upon the determined required computing resources whether sufficient computing resources are available for loading the available software defined radio into the memory. The processor may further be configured to initiate a reboot of loaded software defined radios if sufficient computing resources are not available for loading the available software defined radio. Corresponding methods and computer program products are also provided.

### TECHNOLOGICAL FIELD

Embodiments of the present invention relate generally to mobile communication technology and, more particularly, relate to methods, apparatuses, and computer program products for memory management in devices using software defined radios.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to further improve the convenience to users is the provision of memory management in devices using software defined radios. In this regard, a “radio” may be any hardware, software, firmware, or combination thereof that facilitates transmission and/or receipt of data and/or other communications, such as may be used to facilitate functionality of applications and/or hardware devices embodied on a computing device. Traditionally, such radios have been implemented in hardware, such as in application-specific integrated circuits (ASICs). As technology has evolved, radios are increasingly implemented in software, otherwise known as “software defined radios” such that computer code comprising a software defined radio (SDR) may be executed by a processor of a computing device. Accordingly, components such as mixers, filters, amplifiers, modulators/demodulators, detectors, correlators, Fast Fourier Transform/Inverse Fast Fourier Transform (FFT/IFT), error encoders, Viterbi/Turbo decoders, radio protocol stack, etc., traditionally implemented in hardware, may be implemented in software to comprise an SDR.

These SDRs may be loaded into memory, such as volatile memory, of a computing device for execution by a processor when activated. In some computing devices, SDRs may be dynamically loaded into memory, such that the location of an SDR binary executable in memory may be dynamically determined and allocated during the loading of the SDR. In computing devices having multiple SDRs that may be randomly loaded and unloaded with each SDR being dynamically allocated a block of memory upon being loaded, memory fragmentation may occur wherein free memory blocks space may become divided into many smaller blocks interspersed between memory blocks allocated for use by loaded SDRs or other applications. This memory fragmentation may result in the unavailability of a free memory block large enough to load another SDR. Accordingly, when memory fragmentation reaches such a point, an additional SDR may not be loaded unless one or more currently loaded SDRs are unloaded and then reloaded, thus resulting in at least a temporary lack of radio connectivity. Accordingly, it may be advantageous to provide computing device users with methods, apparatuses, and computer program products for memory management in devices using software defined radios.

### BRIEF SUMMARY OF SOME EXAMPLES OF THE INVENTION

A method, apparatus, and computer program product are therefore provided, which may provide for memory management in devices using software defined radios. In particular, a method, apparatus, and computer program product may be provided to enable, for example, detection of memory fragmentation problems in devices implementing dynamic loading of software defined radios prior to memory fragmentation preventing the loading of a software defined radio that is not currently loaded. In this regard, embodiments of the invention may provide for initiating a reboot sequence comprising unloading and reloading of loaded software defined radios if the severity of memory fragmentation is to an extent such that it is determined that sufficient computing resources are unavailable for loading an available software defined radio that is not currently loaded. Exemplary embodiments of the invention may initiate a reboot sequence at least partially based upon the frequency with which the available software defined radio is loaded concurrently with the currently loaded software defined radios. This frequency may be maintained in a profile comprising data about software defined radio usage for a plurality of software defined radios.

In one exemplary embodiment, a method is provided which may include maintaining a profile comprising data about software defined radio usage for a plurality of software defined radios. The method may further include determining a subset of the plurality of software defined radios. The subset may comprise software defined radios currently loaded into a memory. The method may additionally include determining computing resources required for loading an available software defined radio that is not currently loaded into the memory based at least in part upon the maintained profile and the determined subset. The method may also include determining based at least in part upon the determined required computing resources whether sufficient computing resources are available for loading the available software defined radio into the memory. The method may further include initiating a reboot of loaded software defined radios if sufficient computing resources are not available for loading the available software defined radio.

In another exemplary embodiment, a computer program product is provided. The computer program product includes at least one computer-readable storage medium having computer-readable program instructions stored therein. The computer-readable program instructions may include first, second, third, fourth, and fifth program instructions. The first program instruction is for maintaining a profile comprising data about software defined radio usage for a plurality of software defined radios. The second program instruction is for determining a subset of the plurality of software defined radios. The subset may comprise software defined radios currently loaded into a memory. The third program instruction is for determining computing resources required for loading an available software defined radio that is not currently loaded into the memory based at least in part upon the maintained profile and the determined subset. The fourth program instruction is for determining based at least in part upon the determined required computing resources whether sufficient computing resources are available for loading the available software defined radio into the memory. The fifth program instruction is for initiating a reboot of loaded software defined radios if sufficient computing resources are not available for loading the available software defined radio.

In another exemplary embodiment, an apparatus is provided, which may include a processor. The processor may be configured to maintain a profile comprising data about software defined radio usage for a plurality of software defined radios. The processor may further be configured to determine a subset of the plurality of software defined radios. The subset may comprise software defined radios currently loaded into a memory. The processor may additionally be configured to determine computing resources required for loading an available software defined radio that is not currently loaded into the memory based at least in part upon the maintained profile and the determined subset. The processor may also be configured to determine based at least in part upon the determined required computing resources whether sufficient computing resources are available for loading the available software defined radio into the memory. The processor may further be configured to initiate a reboot of loaded software defined radios if sufficient computing resources are not available for loading the available software defined radio.

In another exemplary embodiment, an apparatus is provided that may include means for maintaining a profile comprising data about software defined radio usage for a plurality of software defined radios. The apparatus may further include means for determining a subset of the plurality of software defined radios. The subset may comprise software defined radios currently loaded into a memory. The apparatus may additionally include means for determining computing resources required for loading an available software defined radio that is not currently loaded into the memory based at least in part upon the maintained profile and the determined subset. The apparatus may also include means for determining based at least in part upon the determined required computing resources whether sufficient computing resources are available for loading the available software defined radio into the memory. The apparatus may further include means for initiating a reboot of loaded software defined radios if sufficient computing resources are not available for loading the available software defined radio.

The above summary is provided merely for purposes of summarizing some example embodiments of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a block diagram of a system for memory management in devices using software defined radios;

FIG. 2 is a schematic block diagram of a mobile terminal according to an exemplary embodiment of the present invention; and

FIG. 3 is a flowchart according to an exemplary method for memory management in devices using software defined radios according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

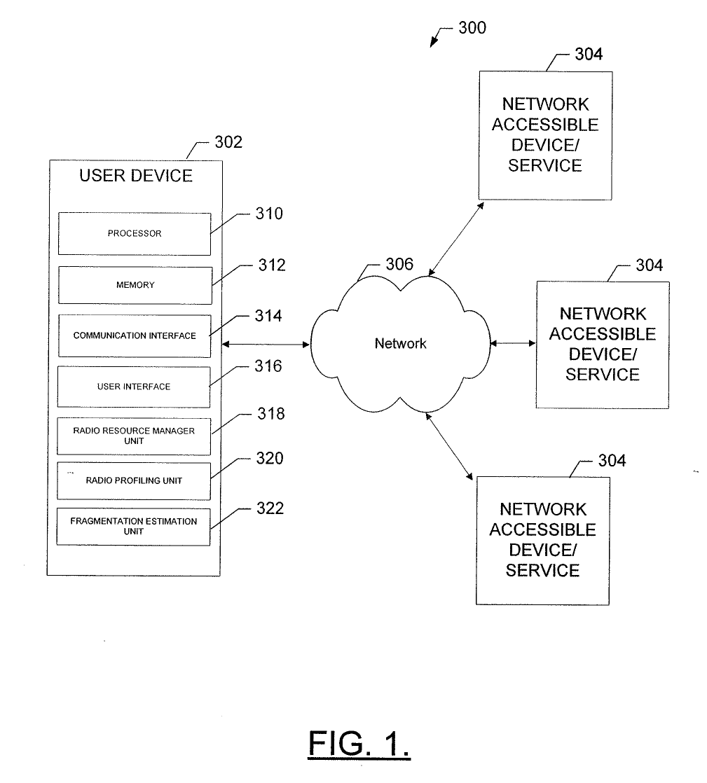

FIG. 1 illustrates a block diagram of a system 300 for managing memory in devices using software defined radios according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. As such, while FIG. 1 illustrates one example of a configuration of a system for managing memory in devices using software defined radios, numerous other configurations may also be used to implement embodiments of the present invention.

As used herein, a “software defined radio (SDR)” refers to any unit of computer code, such as source code or executable code, such as an executable binary, that facilitates wireless transmission and/or receipt of data and/or other communications when executed by a processor. In this regard, an SDR may be used to facilitate functionality of applications and/or hardware devices embodied on a computing device. Examples of software defined radios include, but are not limited to, cellular radio transceivers, wireless local access network (LAN) transceivers, Bluetooth radio transceivers, and Global Positioning System (GPS) transceivers. A “loaded software defined radio (SDR)” refers to a software defined radio that is loaded into a memory, such as a volatile memory, for execution by a processor so as to facilitate communications using the radio protocol defined by the loaded SDR. Accordingly, “loading” an SDR refers to the loading of an SDR code unit into a memory for execution by a processor. An “unloaded software defined radio (SDR)” refers to a software defined radio that is not currently loaded into a memory for execution by a processor. In this regard, an unloaded software defined radio may still be stored in a memory, such as of a non-volatile memory of a user device 302, but it is not loaded into a memory for active execution by a processor. Accordingly, “unloading” an SDR refers to the unloading or removal of an SDR from a memory such that it is no longer executed by a processor.

As used herein, the terms “concurrently,” “concurrently loaded,” “concurrently executed,” etc refer to one or more SDRs that are loaded onto a memory and executed at the same time such that the SDRs are available for use by a user device 302 and/or a user of a user device 302. Accordingly, it will be appreciated that concurrently loaded SDRs does not refer to the process of allocation of memory space during loading of one or more SDRs and thus concurrently loaded SDRs need not be simultaneously loaded into a memory. Indeed, concurrently loaded SDRs may be loaded into a memory sequentially over a period of time, for example. In this regard, “concurrently loaded” refers to a set of SDRs that at a point in time, τ, are loaded into a memory and executed by a processor such that they are available for use.

“Memory fragmentation” as used herein refers to a condition also known as “external fragmentation,” wherein free memory space becomes divided into small pieces over time such that allocated and available or deallocated regions of memory are interspersed throughout the address space of a memory. In this regard, available regions of the memory may be effectively unusable because the regions are too small to satisfy the memory demands of a software application such as an SDR.

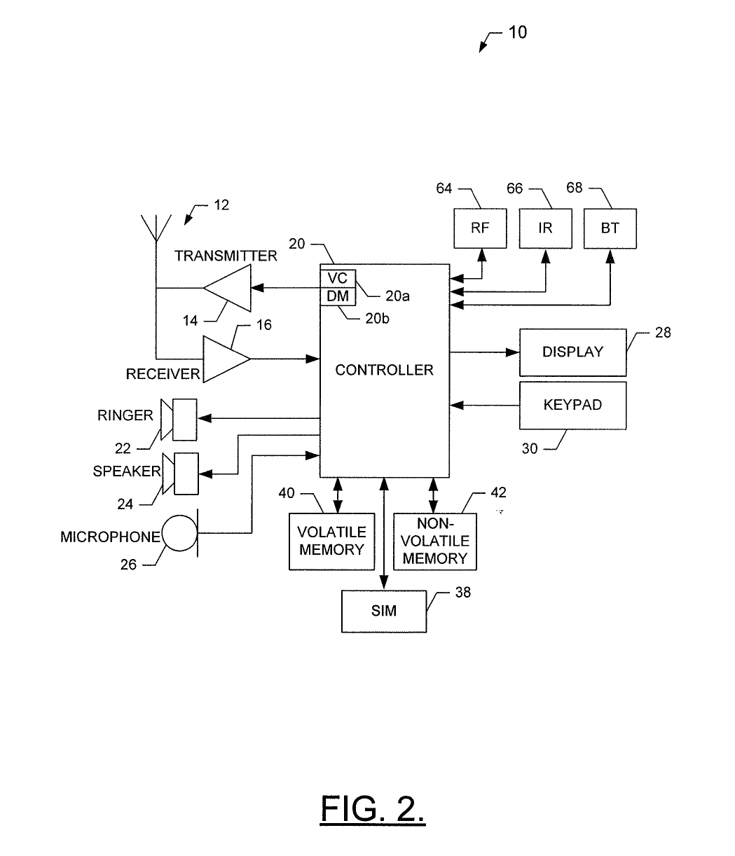

Referring now to FIG. 1, the system 300 may include a user device 302 and a plurality of network accessible devices/services 304 configured to communicate with each other over a network 306, such as via a radio interface. The user device 302 may be any computing device configured to implement SDRs and communicate with remote devices or services, such as a network accessible device/service 304 over a network 306. In this regard, a plurality of SDRs may be embodied on the user device 302. One example of a user device 302 is depicted in FIG. 2.

In this regard, FIG. 2 illustrates a block diagram of a mobile terminal 10 that may function as a user device 302 in accordance with embodiments of the present invention. It should be understood, however, that the mobile terminal illustrated and hereinafter described is merely illustrative of one type of user device 302 that may benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal may also include a controller 20 or other processor(s) that provides signals to and receives signals from the transmitter and receiver, respectively. These signals may include signaling information in accordance with an air interface standard of an applicable cellular system, and/or any number of different wireless networking techniques, comprising but not limited to Wireless-Fidelity (Wi-Fi), wireless local access network (WLAN) techniques such as Institute of Electrical and Electronics Engineers (IEEE) 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) protocols.

It is understood that the controller 20 may comprise circuitry for implementing audio/video and logic functions of the mobile terminal 10. For example, the controller 20 may comprise a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the controller 20. As used herein, “operationally coupled” may include any number or combination of intervening elements (including no intervening elements) such that operationally coupled connections may be direct or indirect and in some instances may merely encompass a functional relationship between components. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, and/or the like. The Bluetooth transceiver 68 may be capable of operating according to Wibree™ radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, the network accessible device/service 304 may be embodied as any computing device, mobile or fixed, and may be embodied as a server, desktop computer, laptop computer, mobile terminal 10, and/or the like. The network accessible device/service 304 may also be embodied as a combination of a plurality of computing devices configured to communicate with a user device 302 over a radio interface. In this regard, the network accessible device/service 304 may be embodied, for example, as a server cluster and/or may be embodied as a distributed computing system, such as may be distributed across a plurality of computing devices, such as, for example, mobile terminals 10. In one embodiment, a network accessible device/service 304 may be one or more satellites, such as a GPS satellite, in communication with the user device 302 over a radio interface. The network 306 may be any network over which the user device 302 and service provider 304 are configured to communicate, such as using a radio interface. Accordingly, the network 306 may be a wireless network, a wireline network, or any combination thereof. The network 306 may be a structured or an ad hoc network. The network 306 may further utilize any communications protocol or combination of communications protocols that may facilitate inter-device communication between the user device 302 and a network accessible device/service 304.

As described above in conjunction with FIG. 2, the user device 302 may include various means, such as a processor 310, memory 312, communication interface 314, user interface 316, radio resource manager unit 318, radio profiling unit 320, and fragmentation estimation unit 322 for performing the various functions herein described. For example, the processor 310 may be embodied as various means including a microprocessor, a coprocessor, a controller, or various other processing elements including integrated circuits such as, for example, an ASIC (application specific integrated circuit) or FPGA (field programmable gate array). The processor 310 may, for example, be embodied as the controller 20 of a mobile terminal 10. In an exemplary embodiment, the processor 310 may be configured to execute instructions stored in the memory 312 or otherwise accessible to the processor 310. Although illustrated in FIG. 2 as a single processor, the processor 310 may comprise a plurality of processors operating in parallel, such as a multi-processor system.

The memory 312 may include, for example, volatile and/or non-volatile memory. In an exemplary embodiment, the memory 312 may be embodied as, for example, volatile memory 40 and/or non-volatile memory 42 of a mobile terminal 10. The memory 312 may be configured to store information, data, applications, instructions, or the like for enabling the user device 302 to carry out various functions in accordance with exemplary embodiments of the present invention. For example, the memory 312 may be configured to buffer input data for processing by the processor 310. Additionally or alternatively, the memory 312 may be configured to store instructions for execution by the processor 310. As yet another alternative, the memory 312 may comprise one or more databases that store information in the form of static and/or dynamic information. In this regard, the memory 312 may store, for example, a profile comprising information about software defined radio usage on the user device 302. The memory 312 may further be configured to store loaded and/or unloaded SDRs. This stored information may be stored and/or used by the radio resource manager unit 318, radio profiling unit 320, and/or the fragmentation estimation unit 322 during the course of performing their functionalities.

The communication interface 314 may be embodied as any device or means embodied in hardware, software, firmware, or a combination thereof that is configured to receive and/or transmit data from/to a network and/or any other device or module in communication with the user device 302. In one embodiment, the communication interface 314 may be at least partially embodied as or otherwise controlled by the processor 310. In this regard, the communication interface 314 may include, for example, an antenna, a transmitter, a receiver, a transceiver and/or supporting hardware or software for enabling communications with other entities of the system 300, such as a network accessible device/service 304 via the network 306. Accordingly, the communication interface 314 may comprise one or more loaded SDRs. The communication interface 314 may additionally be in communication with the memory 312, user interface 316, radio resource manager unit 318, radio profiling unit 320, and/or fragmentation estimation unit 322. The communication interface 314 may be configured to communicate using any protocol, such as may be enabled by loading and executing a software defined radio at the user device 302, by which the user device 302 and network accessible device/service 304 may communicate over the network 306.

The user interface 316 may be in communication with the processor 310 to receive an indication of a user input and/or to provide an audible, visual, mechanical, or other output to the user. As such, the user interface 316 may include, for example, a keyboard, a mouse, a joystick, a display, a touch screen display, a microphone, a speaker, and/or other input/output mechanisms. Accordingly, the user interface 316 may facilitate providing a user of a user device 302 with an indication of current memory fragmentation status, such as a visual indication provided over a display, such as the display 28 of a mobile terminal 10. In this regard, the user interface 316 may further be in communication with the radio resource manager unit 318, radio profiling unit 320, and/or the fragmentation estimation unit 322.

The radio resource manager unit 318 may be embodied as various means, such as hardware, software, firmware, or some combination thereof and, in one embodiment, may be embodied as or otherwise controlled by the processor 310. In embodiments where the radio resource manager unit 318 is embodied separately from the processor 310, the radio resource manager unit 318 may be in communication with the processor 310. The radio resource manager unit 318 may be configured to load and unload SDRs from a memory, such as the memory 312. In this regard, the radio resource manager unit 318 may be configured to load SDRs in response to a user request received via the user interface 316. Additionally or alternatively, the radio resource manager unit 318 may be configured to load and unload SDRs automatically, such as based upon a predefined schedule of SDR activation and deactivation. The radio resource manager unit 318 may additionally be configured to load or unload one or more SDRs based at least in part upon instructions received from the fragmentation estimation unit 322. In some embodiments, the radio resource manager unit 318 may further be configured to determine each time an SDR is to be loaded whether sufficient computing resources are available. In this regard, the radio resource manager unit 318 may be configured to determine whether there are enough hardware resources available for loading the SDR. This determination of whether enough hardware resources are available may comprise determining whether there is a large enough contiguous memory space in the memory 312 for loading the SDR and/or whether the processor 310 has sufficient excess capacity to facilitate loading and executing the SDR.

The radio profiling unit 320 may be embodied as various means, such as hardware, software, firmware, or some combination thereof and, in one embodiment, may be embodied as or otherwise controlled by the processor 310. In embodiments where the radio profiling unit 320 is embodied separately from the processor 310, the radio profiling unit 320 may be in communication with the processor 310. The radio profiling unit 320 may be configured to maintain a profile comprising data about software defined radio usage for a plurality of software defined radios embodied on the user device 302. The radio profiling unit 320 may be configured to determine a subset of available SDRs embodied on the user device 302 that are currently loaded into the memory 312. In this regard, for example, the user device 302 may comprise a GPS radio, cellular radio, and wireless LAN radio. The cellular radio and wireless LAN radio may be concurrently loaded into memory 312 and thus concurrently executed by the processor 310. Accordingly the radio profiling unit 320 may determine the subset of the plurality of software defined radios as comprising the cellular radio and the wireless LAN radio. The radio profiling unit 320 may further be configured to store an indication of each determined subset in a user profile, such as may be maintained in memory 312. In this regard, radio profiling unit 320 may be configured to maintain a profile comprising a history of subsets of software defined radios that have been concurrently loaded. Thus, for each potential subset of available software defined radios implemented on the user device 302, the radio profiling unit 320 may maintain usage data, such as a number of times each particular subset has been concurrently loaded and/or a percentage of the total operation time of the user device 302 that the subset has been concurrently loaded. The radio profiling unit 320 may be configured to determine a subset of implemented software defined radios currently loaded each time a software defined radio is loaded or unloaded by the radio resource manager unit 318.

The radio profiling unit 320 may further be configured to determine and store in the maintained profile a record of a subset of SDRs that were concurrently loaded immediately prior to loading or unloading of a software defined radio as well as an indication of the SDR that was loaded or unloaded. In this regard, the radio profiling unit 320 may be configured to maintain a profile comprising data about a frequency with which each available unloaded software defined radio has been loaded with each subset of SDRs that were concurrently loaded prior to loading the additional SDR. As used herein, the “frequency” may comprise an indication of a raw number of times that an SDR has been loaded with a particular subset that was already loaded and/or a percentage of the number of times that the subset was loaded that the particular additional software defined radio was loaded for concurrent operation with the subset. For example, software defined radios denoted “A”, “B”, “C”, “D”, and “E” may be implemented on the user device 302. SDRs B, D, and E may be concurrently loaded. A user may then load SDR A and accordingly the radio profiling unit 320 may determine that A was loaded concurrently with the subset B, D, E and update the user profile to reflect that A was so loaded with B, D, E already loaded.

The radio profiling unit 320 may further be configured to maintain data about computing resources required for loading a software defined radio in the maintained profile. In this regard, the radio profiling unit 320 may be configured to determine and store data for each SDR about memory and/or processor usage required for loading and executing the respective software defined radio.

The data maintained in the profile by the radio profiling unit 320 may represent SDR usage data determined and stored over a period of time. This period of time may represent the entire usage history of the user device 302 or may represent some shorter period of time. In this regard, the radio profiling unit 320 may be configured to maintain usage data for a predefined period of time, such as, for example four weeks, and then purge data older than that predefined period. The predefined period may be defined by a user of the user device 302. Additionally or alternatively, the radio profiling unit 320 may be configured to purge all SDR usage data in the maintained profile and to begin maintaining a fresh set of data upon a command received from a user of the user device 302.

The fragmentation estimation unit 322 may be embodied as various means, such as hardware, software, firmware, or some combination thereof and, in one embodiment, may be embodied as or otherwise controlled by the processor 310. In embodiments where the fragmentation estimation unit 322 is embodied separately from the processor 310, the fragmentation estimation unit 322 may be in communication with the processor 310. The fragmentation estimation unit 322 may be configured to determine computing resources required for loading an available software defined radio that is not currently loaded and at least partially based upon the determination of required resources to determine whether sufficient computing resources are available for loading the available SDR. In this regard, the fragmentation estimation unit 322 may be configured to determine computing resources required for loading an SDR from the profile maintained by the radio profiling unit 320. The fragmentation estimation unit 322 may be configured to then determine the available computing resources, which may comprise, for example, the largest contiguous block of available unallocated memory address space on the memory 312 and/or available processing power in the user device 302, such as may be provided by the processor 310. The fragmentation estimation unit 322 may then be configured to compare the required computing resources to the available computing resources to determine whether sufficient computing resources are available to load the SDR. If, for example, a SDR that is not loaded requires a memory space larger than the largest contiguous available block in the memory 312, then the fragmentation estimation unit 322 may be configured to determine that sufficient computing resources are not available and a memory fragmentation problem exists.

The fragmentation estimation unit 322 may be configured to determine whether sufficient computing resources are available for individually loading each available software defined radio that is not currently loaded. The sequence in which the determinations are made with respect to each SDR may be determined based at least in part upon the frequency with which each SDR is loaded concurrently with the currently loaded subset of available SDRs. For example, the fragmentation estimation unit 322 may be configured to first determine whether sufficient computing resources are available for loading the SDR with the highest frequency of being loaded concurrently with the currently loaded subset, then the second highest frequency SDR, third highest frequency, etc. The fragmentation estimation unit 322 may be configured to determine whether sufficient computing resources are available for loading one or more SDRs that are not currently loaded following each loading or unloading of a software defined radio.

In another embodiment, the fragmentation estimation unit 322 may be configured to in turn determine whether sufficient computing resources are available for loading each software defined radio that is loaded concurrently with a currently loaded subset of SDRs with a frequency above a predefined threshold. This predefined threshold may be set by a user of the user device 302. In yet another embodiment, the fragmentation estimation unit 322 may be configured to determine whether sufficient computing resources are available for loading two or more SDRs concurrently with the currently loaded subset of SDRs. The fragmentation estimation unit 322 may be configured to make such a determination, for example, when more than one SDR is concurrently loaded with the currently loaded subset with a very high frequency, which may be a predefined threshold.

The fragmentation estimation unit 322 may additionally be configured to initiate a reboot of loaded software defined radios if the fragmentation estimation unit 322 determines that sufficient computing resources are not available for loading an available software defined radio that is not currently loaded. In this regard, initiating a reboot comprises the fragmentation estimation unit 322 instructing the radio resource manager unit 318 to unload each currently loaded software defined radio and then to reload each of the SDRs that were unloaded. In this regard, the code for the reloaded SDRs may now be more substantially contiguous with each other or with other applications loaded into the memory space such that memory fragmentation may be reduced by reducing small blocks of free memory space that previously existed between the memory blocks allocated to the SDRs. The fragmentation estimation unit 322 may instruct the radio resource manager unit 318 to reload the SDRs in a predefined order. This predefined order may be determined at least partially based upon how critical an SDR is for operation of the user device 302, a frequency of use of an SDR, and/or an order for loading the SDRs that may best optimize use of computing resources.

In an exemplary embodiment, the fragmentation estimation unit 322 may be configured to initiate a reboot based at least in part upon a degree of a memory fragmentation problem if sufficient computing resources are not available to load a software defined radio that is not currently loaded. In this regard, the fragmentation estimation unit 322 may be configured to initiate a reboot based at least in part upon a frequency with which a software defined radio for which there are not sufficient computing resources to load has been previously loaded with the currently loaded subset of SDRs. If the frequency is greater than a predefined threshold then the memory fragmentation problem may be regarded as a critical problem and the fragmentation estimation unit 322 may be configured to initiate a reboot immediately or no later than the elapse of a predefined interval of a relatively short length of time, such as 5 minutes. If the frequency is less than a predefined threshold then the memory fragmentation problem may be regarded as a non-critical problem and the fragmentation estimation unit 322 may be configured to initiate a reboot at a predefined time. This predefined time may be a predefined time of day, such as 4:00 AM, when a user is unlikely to be actively using the user device 302 and/or the temporary unavailability of one or more software defined radios is not likely to significantly disrupt user experience. The predefined time may be determined based at least in part upon usage patterns of the user device 302 and/or based at least in part upon a time defined by a user.

The fragmentation estimation unit 322 may further be configured to provide an indication of fragmentation of the memory based at least in part upon the determination whether sufficient computing resources are available for loading an SDR that is not currently loaded. In this regard, the fragmentation estimation unit 322 may be configured to provide an indication that may be provided to a user of the user device 302 via the user interface 316. This indication may be a visual indication that may be displayed to a user over a visual display of the user device 302. In an exemplary embodiment, the fragmentation estimation unit 322 may display a green light on a visual display if there is not a memory fragmentation problem, e.g. each SDR that is not currently loaded for which the fragmentation estimation unit 322 has determined whether sufficient computing resources are available for loading the SDR may be loaded. The fragmentation unit 322 may be configured to display a yellow light if there is a non-critical fragmentation problem, e.g. there are not sufficient computing resources available for loading an SDR, but the frequency with which the SDR is loaded concurrently with the currently loaded subset of SDRs is less than a predefined threshold. The fragmentation unit 322 may further be configured to display a red light if there is a critical fragmentation problem, e.g. there are not sufficient computing resources available for loading an SDR and the frequency with which the SDR is loaded concurrently with the currently loaded subset of SDRs is greater than a predefined threshold. The fragmentation estimation unit 322 may further be configured to provide an indication of any reboot that has been initiated. For example, in the event of a non-critical memory fragmentation problem, the fragmentation estimation unit 322 may be configured to display an indication that a reboot will occur at a particular time of day unless the user takes preemptive action such as by canceling the reboot and/or initiating a reboot sooner, such as manually or by indicating to the fragmentation estimation unit 322 to reboot loaded software defined radios immediately. In another example, in the event of a critical memory fragmentation problem, the fragmentation estimation unit 322 may be configured to display a countdown timer representing a time remaining until loaded software defined radios are rebooted unless the user takes preemptive action such as by canceling the reboot and/or initiating a reboot sooner, such as manually or by indicating to the fragmentation estimation unit 322 to reboot loaded software defined radios immediately.

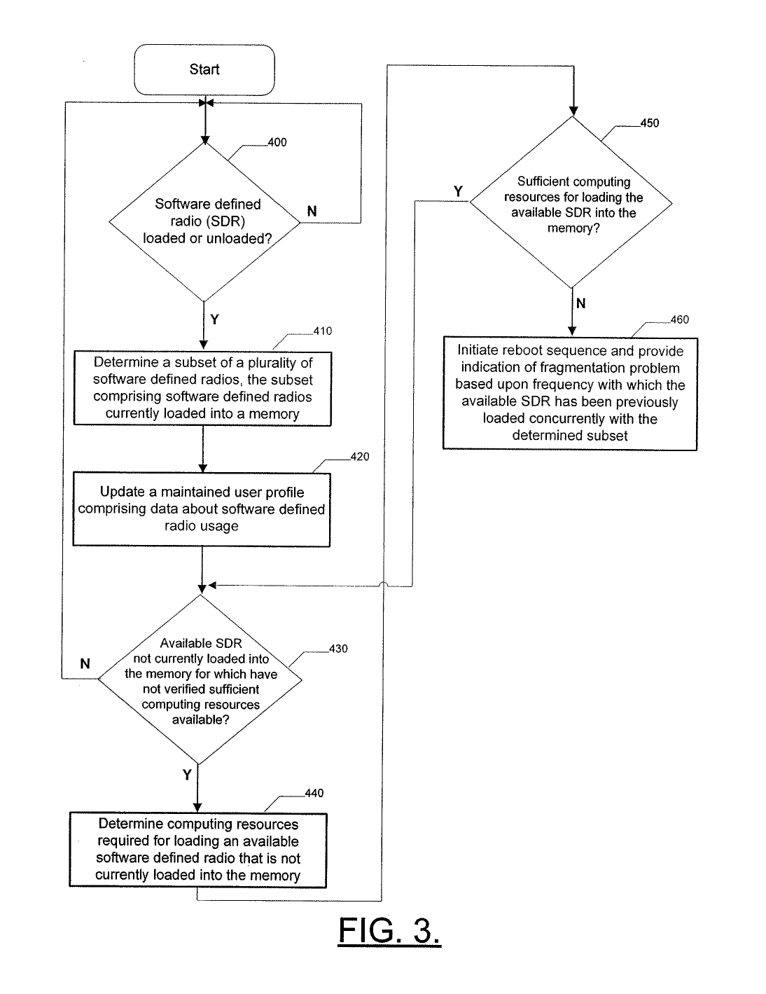

FIG. 3 is a flowchart of a system, method, and computer program product according to an exemplary embodiment of the invention. It will be understood that each block or step of the flowchart, and combinations of blocks in the flowchart, may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal, server, or other computing device and executed by a processor in the computing device. In some embodiments, the computer program instructions which embody the procedures described above may be stored by memory devices of a plurality of computing devices. As will be appreciated, any such computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowcharts, and combinations of blocks or steps in the flowchart, may be implemented by special purpose hardware-based computer systems which perform the specified functions or steps, or combinations of special purpose hardware and computer instructions.

In this regard, one exemplary method for managing memory in devices using software defined radios according to an exemplary embodiment of the present invention is illustrated in FIG. 3. The method may include the radio profiling unit 320 determining whether a software defined radio was loaded or unloaded at operation 400. If no SDR was loaded or unloaded, then the radio profiling unit 320 may be configured to continue to make the determination periodically. If an SDR was loaded or unloaded, then operation 410 may comprise the radio profiling unit 320 determining a subset of a plurality of software defined radios. The subset may comprise SDRs currently loaded. Operation 420 may comprise the radio profiling unit 320 updating a maintained user profile comprising data about software defined radio usage.

Operation 430 may comprise the fragmentation estimation unit 322 determining whether there is an available software defined radio that is not currently loaded for which the fragmentation estimation unit 322 has not verified that sufficient computing resources are available for loading the SDR. If not, meaning that either all available SDRs are currently loaded or the fragmentation estimation unit 322 has already verified that sufficient computing resources are available for loading each SDR that is not currently loaded, then the method returns to operation 400. If there is an SDR that is not currently loaded for which the fragmentation estimation unit 322 has not verified that sufficient computing resources are available, then operation 440 may comprise the fragmentation estimation unit 322 determining computing resources required for loading an available software defined radio that is not currently loaded into the memory. The fragmentation estimation unit 322 may determine this information from the profile maintained by the radio profiling unit 320. Operation 450 may comprise the fragmentation estimation unit 322 determining whether sufficient computing resources are available for loading the software defined radio into the memory. If sufficient computing resources are available, then the method may return to operation 430 such that the fragmentation estimation unit 322 may determine whether sufficient computing resources are available for individually loading each available SDR that is not currently loaded. In an exemplary embodiment of the method, the fragmentation estimation unit 322 may make this determination for each available SDR in order from highest frequency to lowest frequency with respect to the frequency with which an SDR is concurrently loaded with the currently loaded subset of software defined radios. If, however, at operation 450 the fragmentation estimation unit 322 determines that sufficient computing resources are not available for loading the SDR, the fragmentation estimation unit 322 may initiate a reboot sequence at operation 460. In an exemplary embodiment, the fragmentation estimation unit 322 may additionally provide an indication of the memory fragmentation problem at operation 460. Operation 460 may additionally comprise the fragmentation estimation unit 322 initiating the reboot sequence and providing the indication based at least in part upon the frequency with which the available SDR has been previously loaded concurrently with the determined subset.

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention may provide several advantages to a user of a computing device, such as a mobile terminal 10. Embodiments of the invention may provide for memory management in devices using software defined radios. Accordingly, users may benefit from a reduction in forced reboots of software defined radios that may occur, for example, when memory fragmentation interferes with operation of loaded SDRs or when a user attempts to load an SDR and sufficient computing resources are not available. Embodiments of the invention may thus allow for preemptive rebooting of loaded SDRs if a determination is made that sufficient computing resources are not available for loading an SDR that is not currently loaded concurrently with the subset of software defined radios that are currently loaded. The determination may be optimized based at least in part upon a maintained SDR use profile that compiles data about software defined radio usage including frequencies with which various SDRs are concurrently loaded. Accordingly, the severity of any memory fragmentation problems may be intelligently determined based at least in part upon the frequency with which a user loads an SDR and any reboot may be initiated accordingly. Embodiments of the invention may thus provide for reboot of SDRs at a time or in a manner that is less intrusive to a user and thus may result in less inconvenience due to SDR down time.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1.-31. (canceled)

32. A method comprising:
maintaining a profile comprising data about software defined radio usage for a plurality of software defined radios;
determining a subset of the plurality of software defined radios, the subset comprising software defined radios currently loaded into a memory;
determining computing resources for loading an available software defined radio that is not currently loaded into the memory based at least in part upon the maintained profile and the determined subset;
determining based at least in part upon the determined computing resources whether sufficient computing resources are available for loading the available software defined radio into the memory; and
initiating a reboot of loaded software defined radios if sufficient computing resources are not available for loading the available software defined radio.

33. A method according to claim 32, wherein maintaining a profile further comprises maintaining a profile comprising a history of subsets of software defined radios that have been concurrently loaded over a period of time and a frequency with which each available unloaded software defined radio has been previously loaded for each subset of concurrently loaded software defined radios.

34. A method according to claim 32, wherein determining computing resources for loading an available software defined radio that is not currently loaded into the memory further comprises determining computing resources for loading an available software defined radio selected based at least in part upon a frequency with which the available software defined radio has been previously loaded concurrently with the determined subset.

35. A method according to claim 32, wherein initiating a reboot of loaded software defined radios if sufficient computing resources are not available for loading the available software defined radio comprises:
initiating a reboot of loaded software defined radios at a predefined time if the frequency with which the available software defined radio has been previously loaded concurrently with the determined subset is less than a predefined threshold; and
initiating a reboot of loaded software defined radios no later than after elapse of a predefined time interval if the frequency with which the available software defined radio has been previously loaded concurrently with the determined subset is greater than a predefined threshold.

36. A method according to claim 32, further comprising providing an indication of fragmentation of the memory based at least in part upon the determination whether sufficient computing resources are available for loading the available software defined radio into the memory.

37. A method according to claim 32, wherein initiating a reboot of loaded software defined radios if sufficient computing resources are not available for loading the available software defined radio comprises unloading each loaded software defined radio in the determined subset from the memory and reloading each software defined radio in the determined subset into the memory in a predefined order.

38. A computer program product comprising at least one computer-readable storage medium having computer-readable program instructions stored therein, the computer-readable program instructions comprising:
a first program instruction for maintaining a profile comprising data about software defined radio usage for a plurality of software defined radios;
a second program instruction for determining a subset of the plurality of software defined radios, the subset comprising software defined radios currently loaded into a memory;
a third program instruction for determining computing resources for loading an available software defined radio that is not currently loaded into the memory based at least in part upon the maintained profile and the determined subset;
a fourth program instruction for determining based at least in part upon the determined computing resources whether sufficient computing resources are available for loading the available software defined radio into the memory; and
a fifth program instruction for initiating a reboot of loaded software defined radios if sufficient computing resources are not available for loading the available software defined radio.

39. A computer program product according to claim 38, wherein the first program instruction includes instructions for maintaining a profile comprising a history of subsets of software defined adios that have been concurrently loaded over a period of time and a frequency with which each available unloaded software defined radio has been previously loaded for each subset of concurrently loaded software defined radios.

40. A computer program product according to claim 38, wherein the third program instruction includes instructions for determining computing resources for loading an available software defined radio selected based at least in part upon a frequency with which the available software defined radio has been previously loaded concurrently with the determined subset.

41. A computer program product according to claim 38, wherein the fifth program instruction includes instructions for:
initiating a reboot of loaded software defined radios at a predefined time if the frequency with which the available software defined radio has been previously loaded concurrently with the determined subset is less than a predefined threshold; and
initiating a reboot of loaded software defined radios no later than after elapse of a predefined time interval if the frequency with which the available software defined radio has been previously loaded concurrently with the determined subset is greater than a predefined threshold.

42. A computer program product according to claim 38, further comprising a sixth program instruction for providing an indication of fragmentation of the memory based at least in part upon the determination whether sufficient computing resources are available for loading the available software defined radio into the memory.

43. A computer program product according to claim 42, wherein the sixth program instruction includes instructions for:
providing an indication of an absence of a problem with fragmentation of the memory if sufficient computing resources are available for loading the available software defined radio;
providing an indication of a non-critical problem with fragmentation of the memory if sufficient computing resources are not available for loading the available software defined radio and the frequency with which the available software defined radio has been previously loaded concurrently with the determined subset is less than a predefined threshold; and
providing an indication of a critical problem with fragmentation of the memory if sufficient computing resources are not available for loading the available software defined radio and the frequency with which the available software defined radio has been previously loaded concurrently with the determined subset is greater than a predefined threshold.

44. A computer program product according to claim 38, wherein the fifth program instruction includes instructions for unloading each loaded software defined radio in the determined subset from the memory and reloading each software defined radio in the determined subset into the memory in a predefined order.

45. An apparatus comprising:
a processor configured to maintain a profile comprising data about software defined radio usage for a plurality of software defined radios;
a processor configured to determine a subset of the plurality of software defined radios, the subset comprising software defined radios currently loaded into a memory;
a processor configured to determine computing resources for loading an available software defined radio that is not currently loaded into the memory based at least in part upon the maintained profile and the determined subset;
a processor configured to determine based at least in part upon the determined computing resources whether sufficient computing resources are available for loading the available software defined radio into the memory; and
a processor configured to initiate a reboot of loaded software defined radios if sufficient computing resources are not available for loading the available software defined radio.

46. An apparatus according to claim 45, wherein the processor is configured to maintain a profile by maintaining a profile comprising a history of subsets of software defined radios that have been concurrently loaded over a period of time and a frequency with which each available unloaded software defined radio has been previously loaded for each subset of concurrently loaded software defined radios.

47. An apparatus according to claim 45, wherein the processor is configured to determine computing resources for loading an available software defined radio that is not currently loaded into the memory by determining computing resources for loading an available software defined radio selected based at least in part upon a frequency with which the available software defined radio has been previously loaded concurrently with the determined subset.

48. An apparatus according to claim 45, wherein the processor is configured to initiate a reboot of loaded software defined radios if sufficient computing resources are not available for loading the available software defined radio by:
initiating a reboot of loaded software defined radios at a predefined time if the frequency with which the available software defined radio has been previously loaded concurrently with the determined subset is less than a predefined threshold; and
initiating a reboot of loaded software defined radios no later than after elapse of a predefined time interval if the frequency with which the available software defined radio has been previously loaded concurrently with the determined subset is greater than a predefined threshold.

49. An apparatus according to claim 45, wherein the processor is further configured to provide an indication of fragmentation of the memory based at least in part upon the determination whether sufficient computing resources are available for loading the available software defined radio into the memory.

50. An apparatus according to claim 45, wherein the processor is configured to determine a subset by determining a subset of available software defined radios following each loading or unloading of a software defined radio.

51. An apparatus according to claim 45, wherein the processor is configured to initiate a reboot of loaded software defined radios if sufficient computing resources are not available for loading the available software defined radio by unloading each loaded software defined radio in the determined subset from the memory and reloading each software defined radio in the determined subset into the memory in a predefined order.
